(19) United States
(12) Patent Application Publication
(10) Pub. No.: US 2003/0054213 A1
(43) Pub. Date: Mar. 20, 2003

(54) Reforming device and fuel cell system

(75) Inventor: Takashi Ishikawa, Toyota-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 10/238,873

(22) Filed: Sep. 11, 2002

(30) Foreign Application Priority Data
Sep. 11, 2001 (JP) 2001-274825

(51) Int. Cl. H01M 8/06; B01J 8/04

(52) U.S. Cl. 429/19; 422/189; 422/198; 429/20; 422/188

(57) ABSTRACT

A reforming device and a fuel cell system applied with the reforming device which can prevent the deterioration of an water-gas shift catalyst due to the oxidation even when the reforming device is emergently stopped under the unexpected condition such as a power failure. A fuel cell system includes the reforming device and a fuel cell. The reforming device includes a reformer and a water gas shift reactor. The reforming device removes the oxygen included in the atmosphere invading into the water gas shift reactor using hydrogen remained in the reforming device. The fuel cell generates the electric power using a reformate gas reformed by the reframing device as a fuel gas.

This application is based on and claims priority under 35 U.S.C. §119 with respect to Japanese Patent Application No. 2001-274825 filed on Sep. 11, 2001, the entire content of which is incorporated herein by reference.

### FIELD OF THE INVENTION

The present invention relates to a reforming device. More particularly, the present invention pertains to a reforming device and a fuel cell system applied with the reforming device.

### BACKGROUND OF THE INVENTION

Methods for reforming a reforming feedstock such as hydrocarbon and alcohol reformed to be a reformate gas which primarily includes hydrogen using a catalyst has been widely studied. Fuel cells have been developed to apply the reformate gas thereto. The fuel cells correspond to electric batteries which generate electric power by a reverse reaction of the electrolysis using hydrogen and oxygen, which does not exhaust other than water. Thus, the fuel cells have been a focus of constant attention as an environmentally conscious electric power generation device.

The fuel cells are applied as movable fuel cells which are used as the power source for movable objects such as electric vehicles and as stationary fuel cells which are used as the power source for stationary fuel cells available for home and office use. Methanol and gasoline have been studied as a reforming feedstock applied to the fuel cells for movable objects. Natural gas and propane have been studied as a reforming feedstock applied to the stationary fuel cells.

A chemical reaction under a steam reforming of a hydrocarbon fuel such as gasoline, natural gas, and propane generally includes a reforming reaction, a water-gas shift reaction, and selective oxidization reaction. The respective reactions will be explained with respect to the reaction of methane which is the primal ingredient of the natural gas. The reforming reaction causes reactions shown in chemical formulas (1) and (2). Although carbon monoxide is not remained if every carbon monoxide is reacted in the reaction shown as the chemical formula (2), in practice, approximately 9˜12 percentage of the carbon monoxide is remained after the reforming reaction.

CH₄+H₂O→3H₂+CO (1)

CO+H₂O→H₂+CO₂ (2)

The water-gas shift reaction corresponding to the reaction of the chemical formula (2) is performed for reducing the carbon monoxide to generate hydrogen. Approximately one percent of the carbon monoxide is remained after the water gas shift reaction. The carbon monoxide is a poisoning substance for an electrode catalyst of the fuel cell. Thus, it is required to reduce the concentration of the carbon monoxide in the reforming gas supplied to the fuel cell to be equal to or less than 100 ppm, more preferably, equal to or less than 10 ppm.

With the selective oxidation reaction, a predetermined amount of the oxygen is introduced into the gas after the water-gas shift reaction, the reaction of the following chemical formula (3) is caused using a catalyst to selectively oxidize the carbon monoxide to reduce the concentration of the carbon monoxide.

CO+0.50₂→CO₂ (3)

Performances of catalysts applied to the reforming reaction, the water gas shift reaction, and the selective oxidization reaction are apt to decline when contacting oxygen. Particularly, a water gas shift catalyst such as copper and zinc used for the water gas shift reaction is notably deteriorated when being exposed to the oxidizing environment.

Even if all inlets and outlets of the reforming device are blocked in case the reforming gas is remained in the reforming device when the device is not operated, the air from outside the device invades into the device due to the vacuum pressure in the reforming device by the condensation of the water vapor included in the reforming device and the decline of the temperature in the reforming device. Thus, the water gas shift catalyst is deteriorated due to the oxygen in the invading air.

In order to prevent the invasion of the air and the deterioration of the water gas shift catalyst, it is necessary to construct the reforming device to be durable under the vacuum pressure and to have a sealing construction of a vacuum device level. This includes a drawback that the manufacturing cost of the reforming device is increased. According to an experimental system, the reforming gas remained in the reforming device when the reforming device is not operated is substituted with an inert gas such as nitrogen. Notwithstanding, because it takes time to decrease the temperature in the reforming device even after substituting the inert gas for the reforming gas to prevent the inflow of air from the outside, it is required to keep introducing the inert gas until the temperature becomes approximate room temperature for preventing to cause the vacuum pressure in the reforming device. In addition, it is difficult to provide an inert gas cylinder such as nitrogen cylinder in the actual system concerning the problems such as space and maintenance.

A known purge method of the remained gas using the purge gas, which is generated by combusting the inflammable gas in the system, instead of using the inert gas is disclosed in Japanese Patent Laid-Open Publication 2000-277137.

A known fuel cell electric power generation system for supplying the reforming gas and the air, provided with a fuel cell for generating the purge gas by consuming the oxygen included in the air, and for using the generated purge gas instead of the inert gas is disclosed in Japanese Patent Laid-Open Publication 2000-277138.

Notwithstanding, although the known device disclosed in the Japanese Patent Laid-Open Publication 2000-277137 operates under a normal stop of the device, the known device has drawbacks that substitution with the purge gas cannot be performed because other compensative components of the operation of the reforming gas is stopped under the unexpected condition such as a power failure. Even if a purge gas reservoir tank is provided, it becomes difficult to perform the substitution of the purge gas because a control portion and a valve are stopped due to the power failure.

In addition, according to the known device disclosed in the Japanese Patent Laid-Open Publication 2000-277137, the control portion for controlling a gas burner for generating the purge gas, the purge gas reservoir tank for reserving the purge gas, and the control portion for controlling the supply of the purge gas are required. Thus, the known device has drawbacks that the size of the system per so is increased and the manufacturing cost is increased. Further, because oxygen is remained when trying to completely combust the inflammable gas, the drawback appears that the water-gas shift catalyst is deteriorated when using the oxygen containing gas as the purge gas. On the other hand, when trying to completely consume the oxygen, the drawbacks appears that the inflammable gas may be remained or incomplete combustion is caused to generate a gas such as carbon monoxide.

According to the Japanese Patent Laid-Open Publication 2000-277138, it is mentioned that the system functions even if the operation is emergently stopped by reserving the purge gas in the purge gas tank. However, it is difficult to perform the substitution with the purge gas because other compensative components of the reforming device are stopped under the unexpected condition such as the power failure. Further, because a fuel cell for generating the purge gas and the control portion thereof are required, the known device has drawbacks that the size of the system per se is increased and the manufacturing cost is increased.

A need thus exists for a reforming device and a highly reliable fuel cell system applied with the reforming device, which can prevent the deterioration of a water-gas shift catalyst due to the oxidation even when the reforming device is emergently stopped under the unexpected condition such as a power failure.

### SUMMARY OF THE INVENTION

In light of the foregoing, the present invention provides a reforming device which includes a reformer for generating hydrogen from a reforming feedstock, and a water gas shift reactor for generating hydrogen and carbon dioxide from water vapor and carbon monoxide included in a gas generated in the reformer. Oxygen included in air from outside and invading into the water gas shift reactor is removed by the hydrogen remained in the reforming device.

According to another aspect of the present invention, a fuel cell system includes a reforming device, and a fuel cell for generating an electric power using a reformate gas reformed by the reforming device as a fuel gas. The reforming device includes a reformer for generating hydrogen from a reforming feedstock, and a water gas shift reactor for generating hydrogen and carbon dioxide from water vapor and carbon monoxide included in a gas generated in the reformer. Oxygen included in air from outside and invading into the water gas shift reactor is removed by the hydrogen remained in the reforming device.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a systematic view of a fuel cell system according to a first embodiment of the present invention.

FIG. 2 is a systematic view of a fuel cell system according to a second embodiment of the present invention.

FIG. 3 is a systematic view of a fuel cell system according to a third embodiment of the present invention.

FIG. 4 is a cross-sectional view of a deoxidizer according to the third embodiment of the present invention.

FIG. 5 is a systematic view of a fuel cell system according to a fourth embodiment of the present invention.

FIG. 6 is a systematic view of a fuel cell system according to a modification of the first embodiment of the present invention.

FIG. 7 is a systematic view of a fuel cell system according to a modification of the first embodiment of the present invention.

FIG. 8 is a systematic view of a fuel cell system according to a modification of the second embodiment of the present invention.

FIG. 9 is a systematic view of a fuel cell system according to a modification of the second embodiment of the present invention.

FIG. 10 is a systematic view of a fuel cell system according to a modification of the third embodiment of the present invention.

### DETAILED DESCRIPTION OF THE INVENTION

The present invention is based on an idea for removing oxygen from the atmosphere using hydrogen remained in a reforming device and in passages which are in communication with the reforming device before the air invading into the reformer invades into a water gas shift reactor when the reforming device includes the vacuum pressure. That is, according to the present invention, the oxygen from the atmosphere invading into the water gas shift reactor is removed using the hydrogen remained in the reforming device. Embodiments of the reforming device of the present invention will be explained referring to drawing figures as follows.

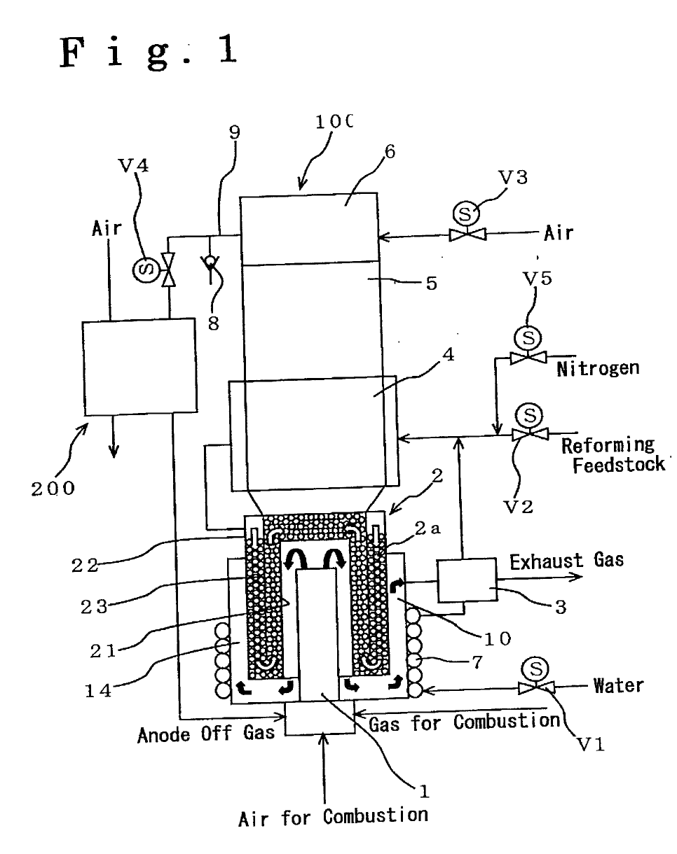

FIG. 1 shows a systematic view of a fuel cell system according to the first embodiment. FIG. 1 mainly shows portions related to the present invention and other compensative components and a control portion are omitted from the drawing. The fuel cell system includes a reforming device 100 and a fuel cell 200 for generating an electric power by using a reformate gas reformed by the reforming device 100 as a fuel gas. The reforming device 100 includes a burner 1, a reformer 2, an evaporator 3, a heat exchanger 4, a water gas shift reactor 5, and a selective oxidizer 6.

The hollow cylindrical burner 1 having a bottom is a device for combusting an inflammable gas (i.e., 13A: natural gas) for heating the reformer 2. The inflammable gas and the air for combustion are introduced into the burner 1. An anode off gas of the fuel cell 200 is also introduced into the burner 1 to be combusted.

The reformer 2 is coaxially provided about the burner 1. The reformer 2 includes an internal wall member 21 of a hollow cylinder having a bottom coaxially provided so that the flame of the burner 1 is cylindrically formed therein, an external wall member 22 of the hollow cylinder, and a separator member 23 of the hollow cylinder provided between the internal wall member 21 and the external wall member 22. A reforming catalyst (i.e., Ru catalyst) 2a is charged in the reformer 2. An exhaust gas passage portion 14 of a hollow cylinder is coaxially provided about the external wall member 22. Heat exchanging pipes 7 are wound about the external periphery of the exhaust gas passage portion 14.

The evaporator 3 is a device for generating a water vapor by evaporating the water by the exhaust gas of the burner 1. The evaporator 3 corresponds to a shell and tube type heat exchanger, which includes two groups of passages extending in two different directions. The exhaust gas of the burner 1 passes through passages extended in one of the directions and the water supplied via a shut valve the heat exchanging pipes 7 passes through the passages extended in the other direction.

The heat exchanger 4 is a device for preheating the water vapor evaporated in the evaporator 3 and a reforming feedstock supplied via a shut valve V2 by the heat of the gas exhausted from the reformer 2. The heat exchanger 4 corresponds to a counter flow type plate fin heat exchanger, which includes two groups of passages extending in two different directions. The gas exhausted from the reformer 2 passes through the passages extended in one of the directions and the reforming feedstock and the water vapor pass through the passages extended in the other direction. The reforming device 100 is constructed so that nitrogen can be supplied to an inlet side of the heat exchanger 4, which is supplied with the reforming feedstock and the water vapor, via a shut valve 5. The inlet of the heat exchanger 4 and an outlet of the reformer 2 are directly connected so that the gas exhausted from the reformer 2 is directly introduced into the heat exchanger 4 without passing through the pipes.

The water gas shift reactor 5 is formed with a cylindrical hollow container and is charged with a water gas shift catalyst (i.e., Cu—Zn catalyst). An inlet of the water gas shift reactor 5 is directly connected to the heat exchanger 4 and an outlet of the water gas shift reactor 5 is directly connected to the selective oxidizer 6.

The selective oxidizer 6 is charged with a selective oxidizer catalyst (i.e., Ru catalyst), is supplied with the gas from the water gas shift reactor 5, and is supplied with the air via a shut valve V3. An outlet of the selective oxidizer 6 is connected to an anode side of the fuel cell 200 via a shut valve V4. The air is supplied to a cathode side of the fuel cell 200. The anode off gas of the fuel cell 200 is supplied to the burner 1.

A one-way valve 8 is provided on a conduit 9 positioned between the outlet of the selective oxidizer 6 and the shut valve V4. The one-way valve 8 is provided for only allowing the airflow from the outside to the conduit 9 direction. That is, the one-way valve 8 only allows the airflow from the outside to the Selective oxidizer 6 direction.

Normal closed valves are applied as the shut valves V1-V5 which are opened when being energized and are automatically closed under non-energizing condition,

When the burner 1 is ignited, the combustion flame is exhausted from a top end of the burner 1 to a space formed between the burner 1 and the internal wall 21 of the reformer 2 to heat the reforming catalyst 2a charged in the reformer 2. The exhaust gas of the combustion flame is exhausted from the exhaust gas passage protion 14 to the outside via the evaporator 3. The exhaust gas heats the reforming catalyst 2a and simultaneously preheats the water passing through the heat exchanging pipes 7 when passing through the exhaust gas passage portion 14. The exhaust gas also evaporates the water supplied via the heat exchanging pipes 7 in the evaporator 3 for supplying to the inlet of the heat exchanger 4.

The reforming feedstock supplied via the shut valve V2 and the water vapor evaporated in the evaporator 3 are mixed at the inlet side of the heat exchanger 4. A mixture of the reforming feedstock and the water vapor is supplied to the space of the reformer 2 formed with the external wall member 22 and the separator member 23 after being preheated up to approximately 500° C. by the heat exchanger 4. The supplied mixture of the water vapor and the reforming feedstock flows in the downward direction of FIG. 1 between the external wall member 22 and the separator member 23, and is supplied to the space between the internal member 21 and the separator member 23 at a bottom end portion to flow upward of FIG. 1 in the space to be exhausted from the reformer 2.

The mixture of the reforming feedstock and the water vapor is reformed to a gas primarily including hydrogen by the reaction shown in the chemical formulas (1) and (2) using the reforming catalyst during passing through the reformer 2 to be supplied to the heat exchanger 4. The combustion amount of the burner 1 is adjusted so that the temperature of the gas exhausted from the reformer 2 stays approximately 650° C.

The gas supplied from the reformer 2 is supplied to the water gas shift reactor 5 after being cooled down to approximately 200-250° C. while heating the mixture of the reforming feedstock and the water vapor in the heat exchanger 4. The carbon monoxide concentration in the gas in this case corresponds to 9-12 percent. The carbon monoxide concentration is reduced to approximately one percent by the reaction of the formula (2) using the water-gas shift catalyst in the water gas shift reactor 5 and the gas is supplied to the selective oxidizer 6.

The air is supplied to the selective oxidizer 6 via the shut valve 3. The carbon monoxide concentration in the selective oxidizer 6 is reduced to equal to or less than 10 ppm by the reaction of the chemical formula (3) using the selective oxidizer catalyst. Then, the reformed gas is exhausted to the conduit 9 as a reformate gas. The reformate gas primarily includes hydrogen and the reformate gas also includes carbon dioxide gas and water vapor.

The reformate gas exhausted into the conduit 9 is supplied to the anode side of the fuel cell 200 as a fuel gas of the fuel cell 200. Air is supplied as an oxidant gas to the cathode side of the fuel cell 200. The fuel cell 200 generates the electricity by the electrode reaction at the cathode electrode using oxygen included in the air and by the electrode reaction at the anode electrode using hydrogen included in the fuel gas. The hydrogen in the fuel gas is not completely used during the electrode reaction at the anode electrode. The hydrogen is remained in the anode off gas, which is supplied to the burner 1 to be combusted.

When the fuel cell system is stopped under the normal condition, supply of the gas for combustion and the air for combustion supplied to the burner 1 is blocked by the control device (not shown), the combustion is stopped, and the shut valves V1-V3 are closed. Simultaneously, the shut valve V5 (i.e., which is always closed when the fuel cell system is operated) is opened to introduce nitrogen gas to the reforming device 100 for performing a nitrogen purge. After the elapse of a predetermined time, the shut valves V4 and V5 are closed.

The predetermined time in this case is determined in accordance with the time during which the temperature in the reforming device 100, particularly, the temperature of the water gas shift reactor 5 is sufficiently cooled down. The time for the nitrogen purge may not be predetermined and, instead, may be determined by detecting the temperature of the water gas shift reactor 5. The detection of the temperature of the water gas shift reactor 5 may be estimated from the temperature of other portions in the reforming device 100 without directly detecting.

When the fuel cell system is emergently stopped under the unexpected condition such as a power failure, the power supply to the shut valves V1-V5 is cut and the shut valves V1-V5 are automatically closed. Thus, the reforming device 100 is completely blocked from the outside and the reformate gas (i.e., primal component; hydrogen) is remained in the reformed device 100.

The reforming device 100 becomes to have the vacuum pressure due to the decrease of the temperature and the condensation of the water vapor. When the reforming device 100 includes the vacuum pressure therein, a small amount of the air (i.e., the atmosphere) enters into the selective oxidizer 6 from the one-way valve 8 via the conduit 9. The oxygen included in the air entered into the selective oxidizer 6 reacts to the hydrogen included in the gas remained in the selective oxidizer 6 to be the water using the selective oxidizer catalyst and is removed. Then, the gas is diffused into the water gas shift reactor 5. Because the oxygen does not exist in the gas diffused in the water gas shift reactor 5, the deterioration of the water-gas shift catalyst due to the oxidation can be prevented.

When the reforming device 100 includes the vacuum pressure, because the external air preferentially invades into the reforming device 100 from the one-way valve 8, the air does not enter the reforming device 100 from other portions of the reforming device 100. Thus, when the reforming device 100 is emergently stopped under the unexpected condition such as the power failure, the external air invades into the reforming device 100 only via the one-way valve provided on the outlet side of the selective oxidizer 6 even when the reforming device 100 includes the vacuum pressure. And oxygen included in the external air becomes the water to be removed by reacting to the hydrogen remained in the selective oxidizer 6. Thus, the deterioration of the water-gas shift catalyst due to the oxidation can be prevented. This fuel cell system is highly reliable because the reformed device 100 which can prevent the deterioration of the water-gas shift catalyst due to the oxidation even when the fuel cell system is emergently stopped under the unexpected condition such as the power failure is provided.

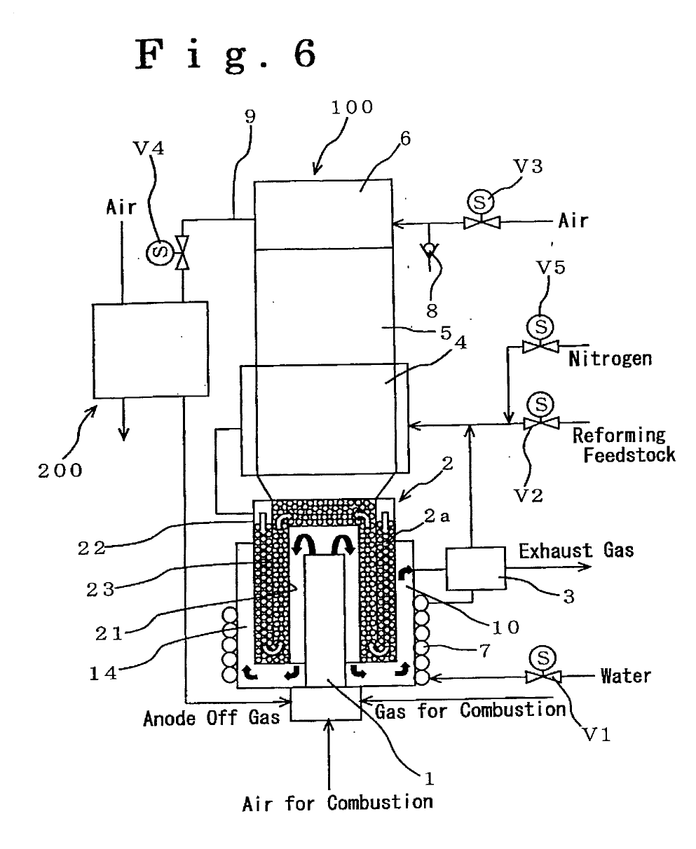

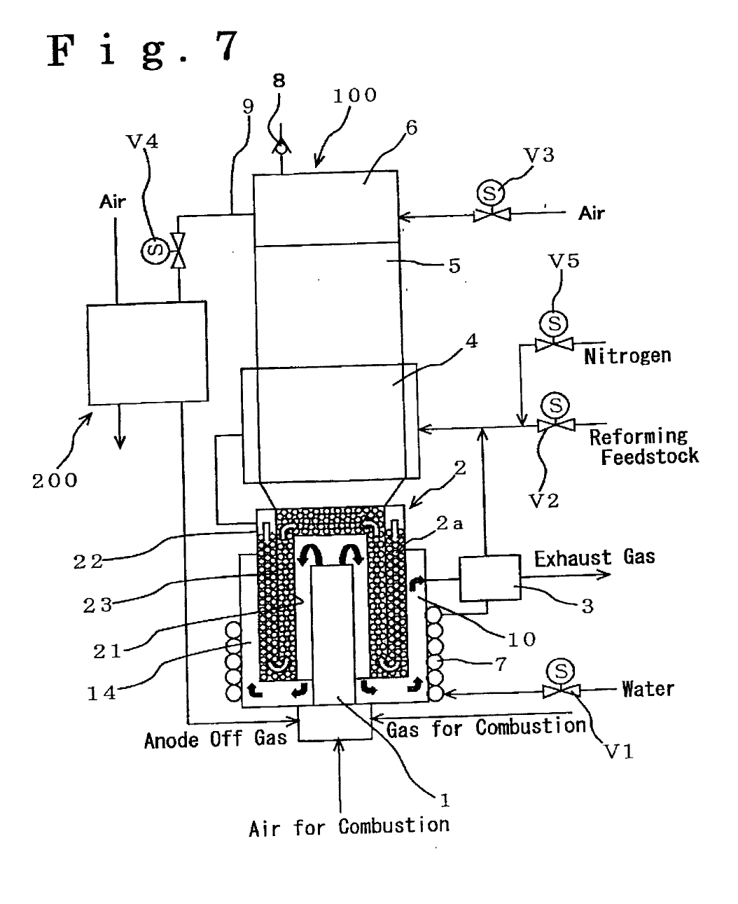

Although the one-way valve 8 is provided on the conduit 9 on the outlet side of the selective oxidizer 6 in the first embodiment, the one-way valve may be provided on a conduit for supplying air into the selective oxidizer 6 via the shut valve 3 (i.e., shown in FIG. 6) and may be directly connected to the selective oxidizer 6 (i.e., shown in FIG. 7). When the one-way valve 8 is provided on the conduit 9 on the outlet side of the selective oxidizer 6, the external air invaded from the one-way valve 8 is diffused into the water gas shift reactor 5 via a long way in the selective oxidizer 6, the oxygen invaded from the outside can be securely removed.

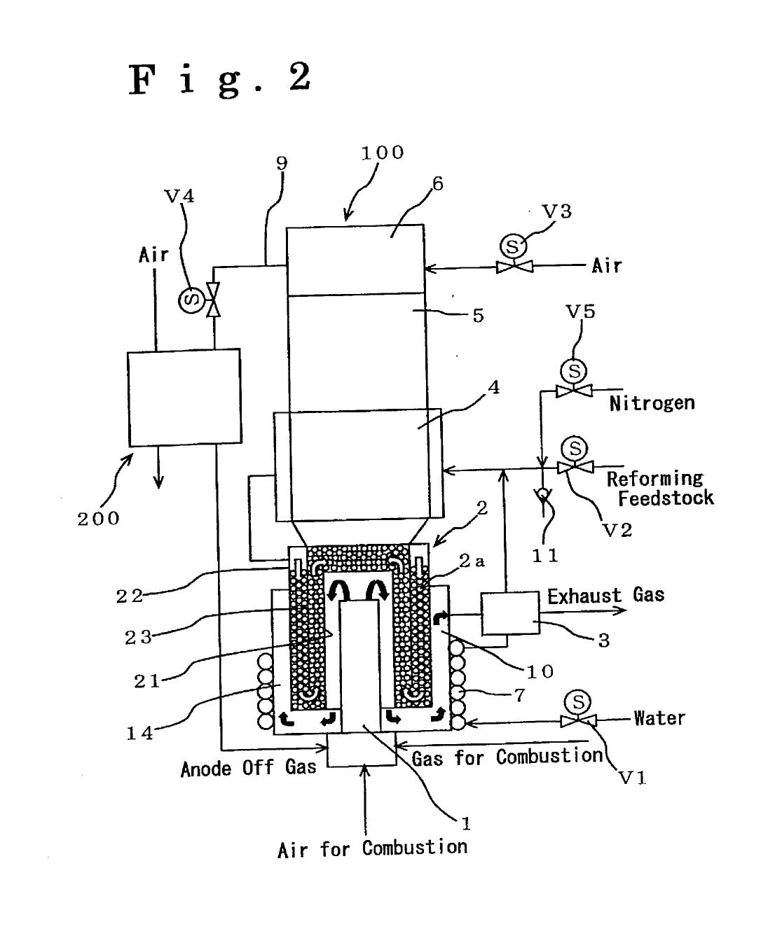

FIG. 2 shows a systematic view of the fuel cell system of a second embodiment of the present invention. The same numerals are provided on portions corresponding to the portions of the first embodiment and the explanation will be omitted. Likewise the first embodiment, FIG. 2 mainly shows portions related to the invention and other compensative components and the control portion are omitted.

According to the second embodiment, a one-way valve 11 is provided on a conduit connecting the shut valve 4 and the heat exchanger 4. The one-way valve 11 is provided so that the airflow only from the outside the heat exchanger 4 direction is allowed. That is, the one-way valve 11 only allows passing the air from the outside to the reformer 2 direction.

When the fuel cell system is stopped under the normal condition, the performance likewise the first embodiment is performed. When the fuel cell system is emergently stopped under the unexpected condition such as the power failure, the combustion is stopped likewise the first embodiment and the shut valves V1-V4 are closed. Thus, the reforming device 100 is completely blocked from the outside and the reformate gas (i.e., primal component is hydrogen) is remained therein.

The reforming device 100 becomes to have the vacuum pressure therein due to the decrease of the temperature and the condensation of the water vapor. When the reforming device 100 includes the vacuum pressure therein, the air (i.e. the atmosphere) enters into the reformer 2 via the heat exchanger 4 by the small amount. The oxygen included in the air invading into the reformer 2 reacts to the hydrogen included in the gas remained inside using the reforming catalyst to be removed. Then, the reformed gas is diffused into the water gas shift reactor 5 via the heat exchanger 4. Because oxygen does not exist in the gas diffused into the water gas shift reactor 5, the deterioration of the water gas shift catalyst due to the oxidation can be prevented.

When the reforming device 100 includes the vacuum pressure, because the external air preferentially invades into the reforming device 100 from the one-way valve 11, the air does not enter the reforming device 100 from other portions of the reforming device 100. Thus, when the reforming device 100 is emergently stopped under the unexpected condition such as the power failure, the external air invades into the reforming device 100 only via the one-way valve provided on the inlet side of the reformer 2 even when the reforming device 100 includes the vacuum pressure, and oxygen included in the external air becomes the water by reacting to the hydrogen remained in the reformer 2 to be removed. Thus, the deterioration of the water gas shift catalyst due to the oxidation can be prevented. This fuel cell system is highly reliable because the reformed device 100 which can prevent the deterioration of the water gas shift catalyst due to the oxidation even when the fuel cell system is emergently stopped under the unexpected condition such as the power failure is provided.

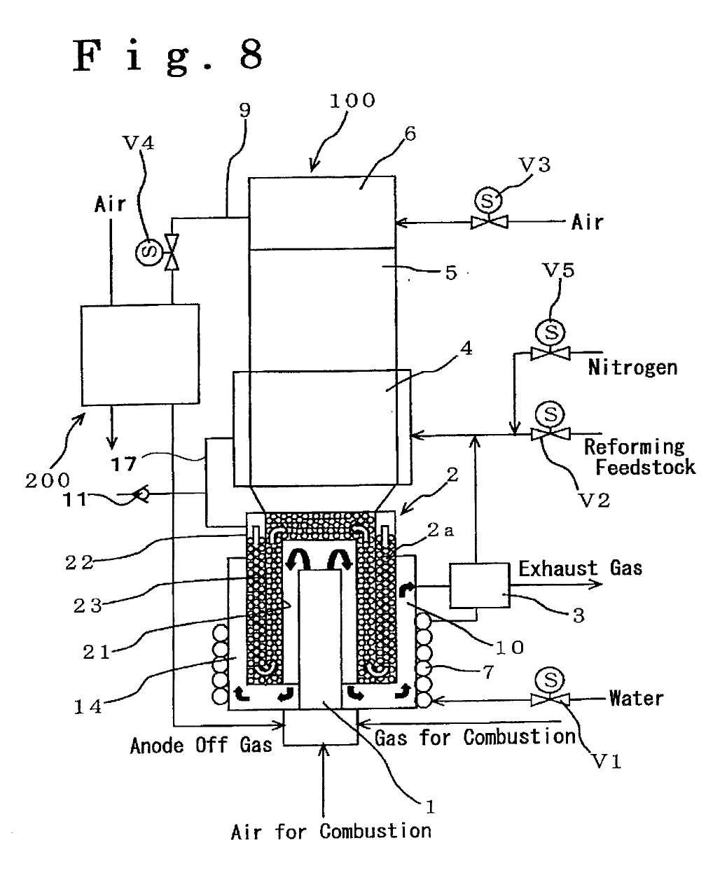

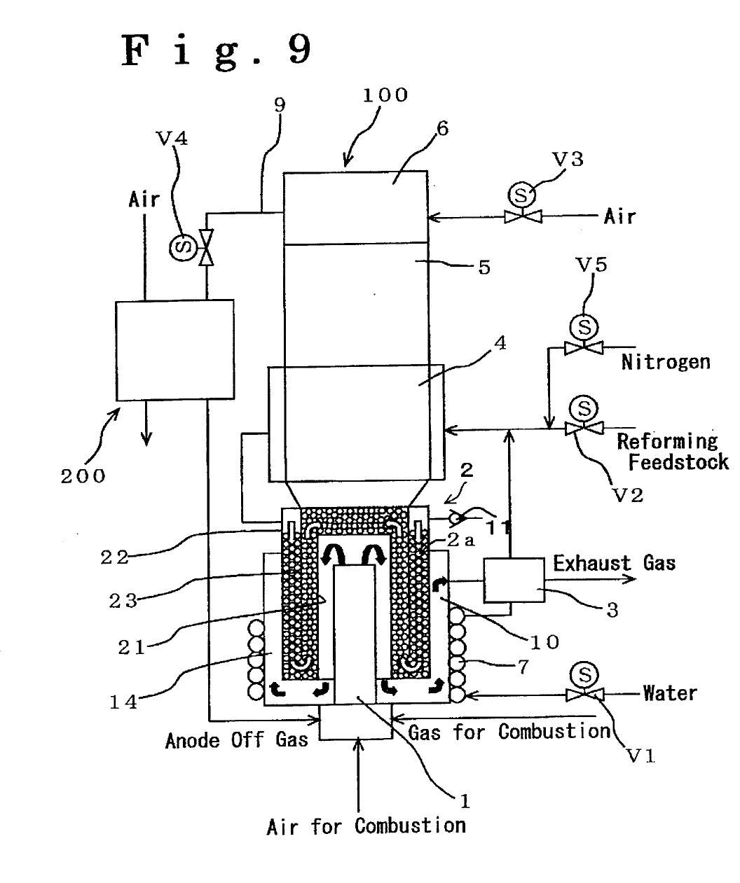

Although the one-way valve 11 is provided on the conduit connecting the shut valve V2 and the heat exchanger 4 in the second embodiment, the one-way valve 11 may be provided on a conduit 17 connecting the heat exchanger 4 and the reformer 2 (i.e., shown in FIG. 8) or may be directly connected to the reformer 2 (i.e., shown in FIG. 9). When the one-way valve 11 is provided on the conduit connecting the shut valve V2 and the heat exchanger 4 or on the conduit connecting the heat exchanger 4 and the reformer 2, the external air invaded from the one-way valve 11 is diffused into the water gas shift reactor 5 via a long passage in the reformer 2. Thus, the oxygen invaded from the external air can be securely removed.

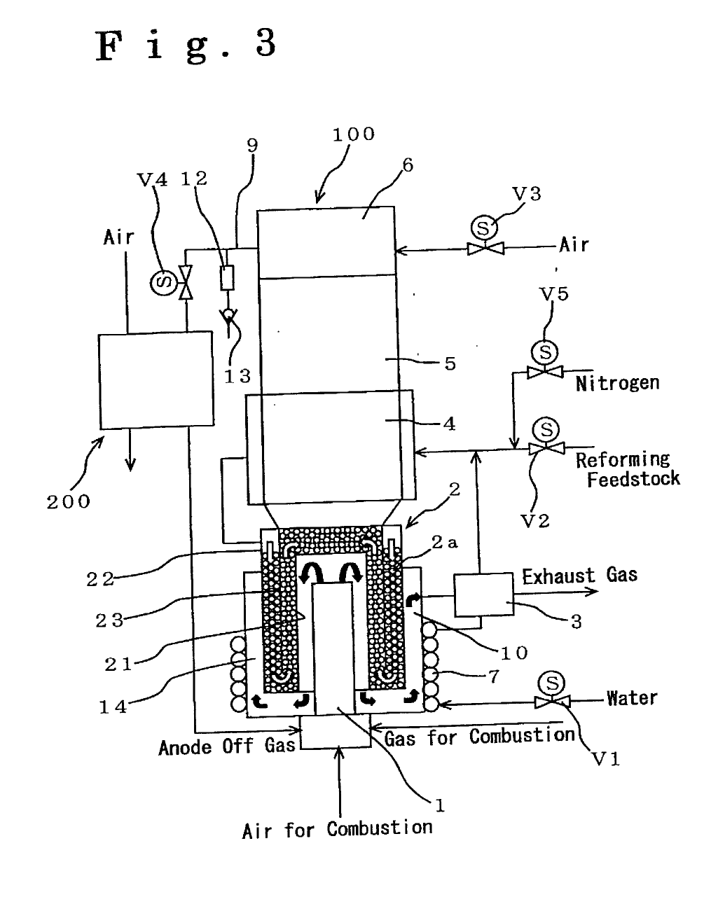

FIG. 3 shows a systematic view of a fuel cell system according to a third embodiment of the present invention. The same numerals are provided on portions corresponding to the portions of the first embodiment and the explanation will be omitted. Likewise the first embodiment, FIG. 3 mainly shows portions related to the invention and other compensative components and the control portion are omitted.

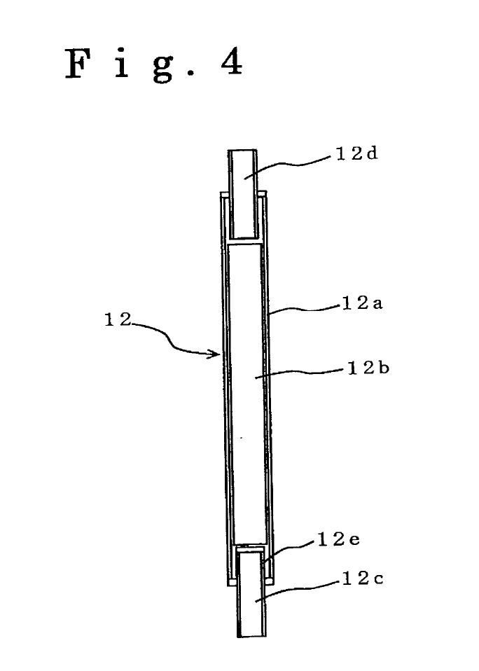

According to the third embodiment, as shown in FIG. 3, a deoxidizer 12 is provided on the conduit 9 and a one-way valve 13 is provided on the deoxidizer 12. The one-way valve 13 is provided for only allowing passing the airflow from the outside to the deoxidizer 12 direction. FIG. 4 shows a cross-sectional view of the deoxidizer 12 of the third embodiment. The deoxidizer 12 includes a catalyst layer portion 12b provided in a cylindrical coat portion 12a and charged with a deoxidizer catalyst (i.e., Pt catalyst), an inlet portion 12c provided on one end of the coat portion 12a, and an outlet portion 12d provided on the other end of the coat portion 12a. The inlet portion 12c is connected to the one-way valve 13 and the outlet portion 12d is connected to the conduit 9. The outlet portion 12d is formed with a hollow cylinder having both ends open. On the other hand, the inlet portion is formed with a hollow cylinder having a bottom. The catalyst layer portion 12b side of the inlet portion 12c has the bottom and two small-diameter bores 12e, 12e having diameter of 0.2 mm are provided on a sides surface near the bottom. With this construction, sudden inflow of the external air is prevented.

When the fuel cell system is stopped under the normal condition, the performance likewise the first embodiment is performed. When the fuel cell system is emergently stopped under the unexpected condition such as the power failure, the combustion is stopped likewise the first embodiment and the shut valves V1-V4 are closed. Thus, the reforming device 100 is completely blocked from the outside and the reformate gas (i.e., primal component is hydrogen) is remained inside. The deoxidizer 12 is filled with the reformate gas exhausted from the reforming device 100.

The reforming device 100 becomes to have the vacuum pressure therein due to the condensation of the water vapor and the decrease of the temperature. When the reforming device 100 becomes to have the vacuum pressure, the air (i.e., the atmosphere) enters into the deoxidizer 12 from the one-way valve 13 by small amount. The oxygen included in the air entered into the deoxidizer 12 reacts to the hydrogen included in the gas remained inside using the deoxidizer catalyst charged in the deoxidizer 12 and is removed. Then, the gas is diffused into the selective oxidizer 6 via the conduit 9 after removing process of the oxygen by the deoxidizer 12. Because the oxygen is not remained in the gas diffused into the water gas shift reactor 5, the deterioration of the water-gas shift catalyst due to the oxidation can be prevented. A diffusion coefficient of hydrogen is greater than a diffusion coefficient of oxygen. Thus, considering only about the diffusion, the oxygen never enters the region filled with the hydrogen as long as the hydrogen is remained. This action is applied to other embodiments as well.

When the reforming device 100 includes the vacuum pressure, because the external air preferentially invades into the reforming device 100 from the one-way valve 13, the air does not enter the reforming device 100 from other portions of the reforming device 100. Thus, when the reforming device 100 is emergently stopped under the unexpected condition such as the power failure, the external air invades into the reforming device 100 only via the one-way valve 13 provided on the deoxidizer 12 which is connected to the outlet side of the reforming device 100 even when the reforming device 100 includes the vacuum pressure. Then, the oxygen included in the external air becomes the water by reacting to the hydrogen remained in the deoxidizer 12 to be removed. Thus, the deterioration of the water gas shift catalyst due to the oxidation can be prevented. This fuel cell system is highly reliable because the reformed device 100 which can prevent the deterioration of the water gas shift catalyst due to the oxidation even when the fuel cell system is emergently stopped under the unexpected condition such as the power failure is provided.

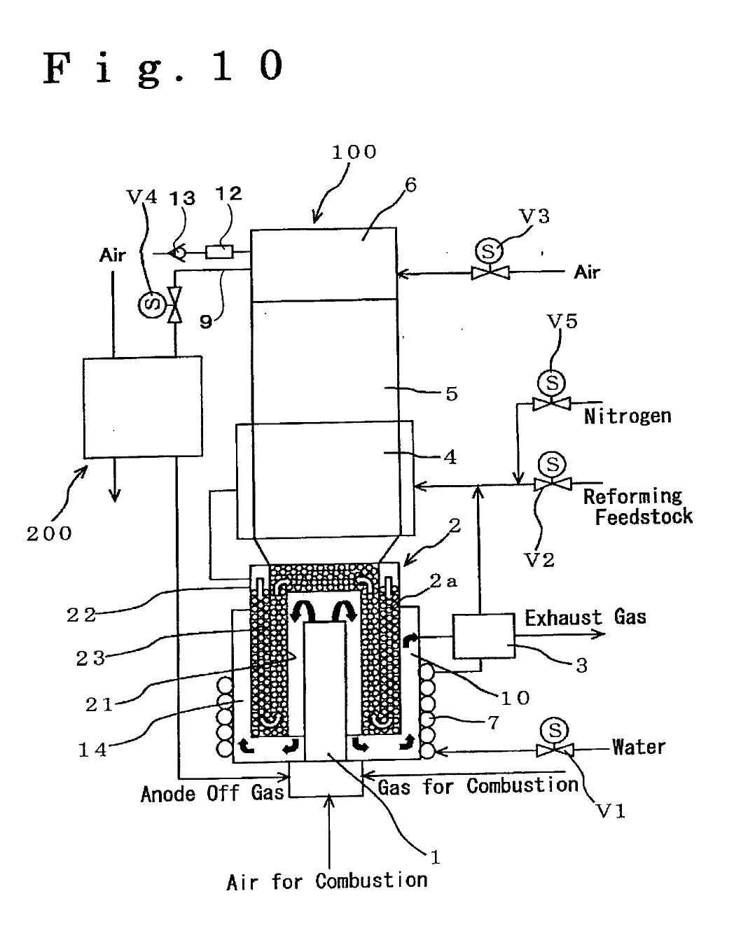

According to the reforming device of the third embodiment, even if the oxygen cannot be completely removed in the deoxidizer 12, the oxygen from the atmosphere can be removed by reacting to the hydrogen remained in the selective oxidizer 6 at the selective oxidizer 6 likewise the reforming device of the first embodiment. Although the deoxidizer 12 is provided on the conduit 9 of the outlet side of the selective oxidizer 6, the deoxidizer 12 may be directly connected to the selective oxidizer 6 (i.e., shown in FIG. 10).

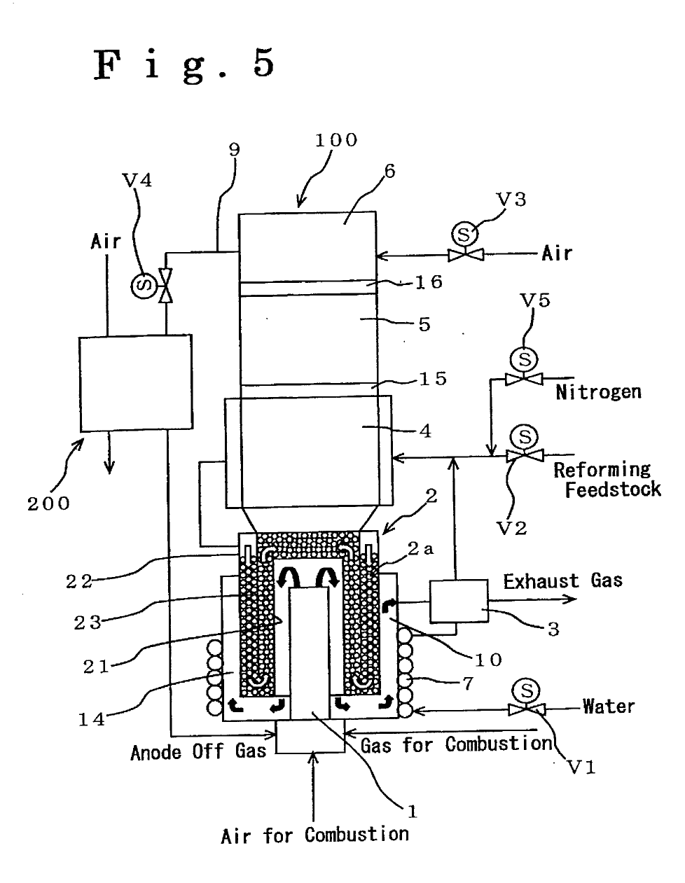

FIG. 5 is a systematic view of a fuel cell system of a fourth embodiment. The same numerals are provided on portions corresponding to the portions of the first embodiment and the explanation will be omitted. Likewise the first embodiment, FIG. 5 mainly shows portions related to the invention and other compensative components and the control portion are omitted.

According to the fourth embodiment a deoxidizer 15 is provided on the inlet side of the water gas shift reactor 5 and a deoxidizer 16 is provided on the outlet side of the water gas shift reactor 5. The water gas shift reactor 5 is formed with a cylindrical hollow container. The deoxidizers 15, 16 are disc shaped having the same diameter with the water gas shift reactor 5 and is provided on the entire surface of the inlet side and the outlet side of the water gas shift reactor 5 so that the gas cannot invade into the water gas shift reactor 5 without passing through the deoxidizers 15, 16. Connecting portions between the water gas shift reactor 5 and the deoxidizer 15 and between the water gas shift reactor 5 and the deoxidizer 16 are sealed with gaskets respectively. The deoxidizer catalyst (Pt catalyst) is charged into the deoxidizers 15, 16.

When the fuel cell system is stopped under the normal condition, the performance is performed likewise in the first embodiment. When the fuel cell system is emergently stopped under the unexpected condition such as the power failure, the combustion is stopped likewise in the first embodiment and the shut valves V1-V4 are closed. Thus, the reforming device 100 is completely blocked from the outside and the reformate gas (i.e., primal component: hydrogen) is remained in the reforming device 100.

The reforming device 100 becomes to have the vacuum pressure therein due to the condensation of the water vapor and the decrease of the temperature. When the reforming device 100 includes the vacuum pressure, the air (i.e., the atmosphere) enters into the reforming device 100 by small amount via connecting portions of each portion of the reforming device 100. The air entered into the reforming device 100 is gradually diffused into the deoxidizer 15 and the deoxidizer 16. The oxygen included in the air to be invaded into the deoxidizer 15 and the deoxidizer 16 reacts to the hydrogen included in the gas remained using the deoxidizer catalyst to be removed. Then, the gas is diffused into the water gas shift reactor 5. Because the gas diffused into the water gas shift reactor 5 does not include oxygen, the deterioration of the water gas shift catalyst due to oxidation can be prevented.

Accordingly, when the reforming device 100 is emergently stopped under the unexpected condition such as the power failure, even if the external air invades into the reforming device 100 due to the vacuum pressure in the reforming device 100, the oxygen included in the external air reacts to the hydrogen remained in the deoxidizers 15, 16 provided on the inlet and the outlet sides of the water gas shift reactor 5 respectively using the deoxidizer catalyst therein. The oxygen is converted into the water to be removed. Thus, the deterioration of the water gas shift catalyst due to the oxidation can be prevented. This fuel cell system is highly reliable because the reformed device 100 which can prevent the deterioration of the water gas shift catalyst due to the oxidation even when the fuel cell system is emergently stopped under the unexpected condition such as the power failure is provided.

Although the connecting portions between the water gas shift reactor 5 and the deoxidizer 15 and between the water gas shift reactor 5 and the deoxidizer 16 are sealed with the gaskets respectively, the water gas shift reactor 5, the deoxidizer 15 and the deoxidizer 16 may be formed in one hollow cylinder. The construction for sealing with the gasket has advantages that it makes the manufacturing process easy and that it excels in the maintenance. With the construction for including the water gas shift reactor 5, the deoxidizer 15 and the deoxidizer 16 in the cylinder, the air is completely prevented to enter in the water gas shift reactor 5 from a clearance between the water gas shift reactor 5 and the deoxidizer 15 or between the water gas shift reactor 5 and the deoxidizer 16.

Although Ru catalyst is applied as the reforming catalyst, Cu—Zn catalyst is applied as the water-gas shift catalyst, Pt catalyst is applied as the selective oxidizer catalyst, and Pt catalyst is applied as the deoxidizer catalyst in the first through the fourth embodiments, the catalysts are not limited to the above and catalysts having respective functions can be applied. For example, Rh catalyst and Ni alloy catalyst may be applied as the reforming catalyst, Ni alloy catalyst may be applied as the water-gas shift catalyst, Ru catalyst and Pt catalyst may be applied as the selective oxidizer catalyst, and Pd catalyst, Rh catalyst, and Ru catalyst may be applied as the deoxidizer catalyst.

The present invention is not limited to the construction shown in the fist trough the fourth embodiments and may be applied to all reforming device and the fuel cell system applied with the reforming device achieving the scope of the present invention. For example, the reforming device may be applied to a construction in which the reforming portion the water gas shift reactor, and the selective oxidizer are not directly connected. Further, in case the carbon monoxide can be sufficiently reduced at the water gas shift reactor and when the poisoning resistance characteristics of the fuel cell is improved, the reforming device can be supplied to a structure which does not include the selective oxidizer except the case of the first embodiment.

According to the embodiments of the present invention, the deterioration of the water gas shift catalyst due to the oxidation can be prevented when the reforming device is emergently stopped under the unexpected condition such as the power failure, and thus, the highly reliable reforming device and the fuel cell system applied with the reforming device can be provided.

According to the embodiments of the present invention, because the oxygen included in the external air invading into the water gas shift reactor can be removed by the hydrogen remained in the reforming device, the invasion of the oxygen into the water gas shift catalyst can be prevented even when the reforming device is emergently stopped under the unexpected condition. Thus, the deterioration of the water gas shift catalyst due to the oxidation can be prevented.

According to the embodiments of the present invention, when the reforming device is emergently stopped under the unexpected condition such as the power failure, the external air invades into the reforming device via the one-way valve provided on the selective oxidizer even under vacuum pressure in the reforming device and the oxygen in the external air becomes the water by reacting to the hydrogen remained in the selective oxidizer to be removed. Thus, the invasion of the oxygen in the water-gas shift catalyst can be prevented and thus the deterioration of the water-gas shift catalyst due to the oxidation can be prevented.

According to the embodiments of the present invention, when the reforming device is emergently stopped under the unexpected condition such as the power failure, the external air invades into the reforming device via the one-way valve provided on the reformer even under the vacuum pressure in the reforming device and the oxygen in the external air becomes the water by reacting to the hydrogen remained in the reformer to be removed. Thus, the invasion of the oxygen in the water gas shift catalyst can be prevented and thus the deterioration of the water gas shift catalyst due to the oxidation can be prevented.

According to the embodiments of the present invention, when the reforming device is emergently stopped under the unexpected condition such as the power failure, the external air invades into the reforming device via the one-way valve provided on the deoxidizer connected to the outlet side of the reforming device even under the vacuum pressure in the reforming device and the oxygen included in the external air becomes the water by reacting to the hydrogen remained in the deoxidizer to be removed. Thus, the invasion of the oxygen in the water gas shift catalyst can be prevented and the deterioration of the water gas shift catalyst due to the oxidation can be prevented.

According to the embodiments of the present invention, when the reforming device is emergently stopped under the unexpected condition such as the power failure, the oxygen included in the external air reacts to the hydrogen remained in the deoxidizer catalyst provided on the inlet side and the outlet side of the water gas shift reactor to become the water to be removed even when the reforming device includes the vacuum pressure and the external air invades into the reforming device. Thus, the invasion of the oxygen in the water gas shift catalyst can be prevented and thus the deterioration of the water gas shift catalyst due to the oxidation can be prevented.

According to the embodiment of the present invention, the reforming device which can prevent the deterioration of the water gas shift catalyst due to the oxidation even under the emergent stop of the reforming device under the unexpected condition such as the power failure, the deterioration of the reforming device can be prevented under the unexpected condition and the highly reliable fuel cell system can be provided.

The principles, preferred embodiment and mode of operation of the present invention have been described in the foregoing specification. However, the invention which is intended to be protected is not to be construed as limited to the particular embodiments disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A reforming device comprising:
a reformer for generating hydrogen from a reforming feedstock; and
a water gas shift reactor for generating hydrogen and carbon dioxide from water vapor and carbon monoxide included in a gas generated in the reformer;
wherein oxygen included in air from outside and invading into the water gas shift reactor is removed by the hydrogen remained in the reforming device.

2. A reforming device according to claim 1, further comprising:
a selective oxidizer for selectively oxidizing the carbon monoxide included in
a gas exhausted from the water gas shift reactor; and
a one-way valve for allowing a flow of air in one direction from atmosphere to the selective oxidizer.

3. A reforming device according to claim 1, further comprising:
a one-way valve for allowing a flow of air in one direction from outside to the reformer.

4. A reforming device according to claim 1, further comprising:
a deoxidizer connected to an outlet side of the reforming device; and
a one-way valve for allowing a flow of air in one direction from outside to the deoxidizer.

5. A reforming device according to claim 1, further comprising:
a deoxidizer provided on an inlet side of the water gas shift reactor and on an outlet side of the water gas shift reactor.

6. A fuel cell system comprising:
a reforming device; and
a fuel cell for generating an electric power using a reformate gas reformed by the reforming device as a fuel gas; wherein
the reforming device comprises
a reformer for generating hydrogen from a reforming feedstock; and
a water gas shift reactor for generating hydrogen and carbon dioxide from water vapor and carbon monoxide included in a gas generated in the reformer; wherein
oxygen included in air from outside and invading into the water gas shift reactor is removed by the hydrogen remained in the reforming device.

7. A fuel cell system according to claim 6, wherein the reforming device further comprises
a selective oxidizer for selectively oxidizing the carbon monoxide included in a gas exhausted from the water gas shift reactor; and
a one-way valve for allowing a flow of air in one direction from atmosphere to the selective oxidizer.

8. A fuel cell system according to claim 6, wherein the reforming device further comprises a one-way valve for allowing a flow of air in one direction from outside to the reformer.

9. A fuel cell system according to claim 6, wherein the reforming device further comprises
a deoxidizer connected to an outlet side of the reforming device; and
a one-way valve for allowing a flow of air in one direction from outside to the deoxidizer.

10. A fuel cell system according to claim 6, wherein the reforming device further comprises
a deoxidizer provided on an inlet side of the water gas shift reactor and on an outlet side of the water gas shift reactor.

11. A reforming device according to claim 2, wherein the one-way valve is provided on an outlet side of the selective oxidizer.

12. A reforming device according to claim 2, wherein the one-way valve is provided on a conduit for supplying air to the selective oxidizer.

13. A reforming device according to claim 2, wherein the one-way valve is directly connected to the selective oxidizer.

14. A reforming device according to claim 3, wherein the one-way valve is provided on a conduit connecting to an inlet side of a heat exchanger.

15. A reforming device according to claim 3, further comprising a heat exchanger for preheating the water vapor and the reforming feedstock;
wherein the one-way valve is provided on a conduit connecting the heat exchanger and the reformer.

16. A reforming device according to claim 3, wherein the one-way valve is directly connected to the reformer.

17. A reforming device according to claim 4, wherein the deoxidizer is provided on a conduit on an outlet side of the selective oxidizer.

18. A reforming device according to claim 4, wherein the deoxidizer is directly connected to the selective oxidizer.
